(19) United States
(12) Patent Application Publication
(10) Pub. No.: US 2011/0122410 A1
(43) Pub. Date: May 26, 2011

(54) Optical Reflectometry Setup

(75) Inventors: Guoliang Wang, Gotenborg (SE); Michael Rodal, Gotenborg (SE)

(73) Assignee: BIOLIN SCIENTIFIC AB, (SE)

(21) Appl. No.: 12/745,349

(22) PCT Filed: Nov. 26, 2008
(86) PCT No.: PCT/SE08/51355

§ 371 Date: Dec. 23, 2010

Related U.S. Application Data
(60) Provisional application No. 60/996,648, filed on Nov. 28, 2007.

(51) Int. Cl. G01J 4/00; G01N 21/55

(52) U.S. Cl. 356/369

(57) ABSTRACT

In the present invention, we present a robust technical approach of how the use of a modified detector set-up eliminates a complication in relation to the usage of prism-based optical reflectometry in contact with liquid sample suspension. Additionally we disclose how molecular interactions at a solid-liquid interface can be investigated simultaneously using optical reflectometry. combined with other techniques that do not have technical interference with reflectometry when sharing the same solid sensing surface, for instance with a quartz crystal microbalance of some suitable type.

### TECHNICAL FIELD

The present invention relates to a modified optical reflectometry set-up which can be used in the elimination of a complication in relation to the usage of prism-based optical reflectometry in contact with fluid sample. Additionally we disclose how molecular interactions at a solid-liquid interface can be investigated simultaneously by a quartz crystal microbalance and said modified optical reflectometry set-up.

### BACKGROUND OF THE INVENTION

Studies of biomolecular interactions at solid surfaces have attracted considerable interest in recent decades, and many analytical techniques have been developed to investigate and quantify deposited amounts, adsorption kinetics, binding affinities or structural changes within biomolecular interfacial layers. The desire to study such phenomena without introducing labels such as fluorophores or radioactive compounds, has led to the development of a multitude of transducer principles. The most common are based on optical, electro-acoustical and electrical detection principles.

Typical optical techniques that provide real-time and label-free analysis are surface plasmon resonance (SPR), ellipsometry, reflectometry, reflectometric interferometric spectroscopy (RIFS) and optical waveguide techniques. While being different in their technical implementation, the sensitivity for two key parameters is common to all of these methods: these are the effective refractive index and the effective thickness of a biomolecular layer at or close to the solid surface. Since the refractive index, to a first approximation, scales linearly with biomolecular concentration, the mass of the adsorbed layers can commonly be derived.

Reflectometry is an optical technique that has been used to detect absorption of biomolecules or polymers on solid surfaces for many years (J. C. DO, M. A. Cohen Stuart and G. J. Feleer, Adv. Colloid Interface Sci., 1994, 50, 79-101). In a conventional setup (FIG. 1), a beam of linearly polarized, monochromatic light (1) is guided through a prism (2) at an oblique angle of incidence to the sensing surface of interest (3). The intensities, Iₚ and Iₛ of the reflected light that is polarized parallel and perpendicular, respectively, to the plane of incidence are continuously measured and recorded by photo detectors (6 and 7), and their ratio S=Iₚ/Iₛ is used as the output of the system. Upon adsorption or desorption of, for example, biomolecules on the sensing surface interface (3), S varies due to changes in the effective thickness and/or the effective refractive index of the forming layer. If the optical properties of the sensing surface are appropriately designed and the angle of incidence of the probe beam is set close to the Brewster/Pseudo-Brewster angle of the surface under the ambient medium, the following relationship can be found under the assumption that the adsorption at the prism/solution interface can be neglected

$$d ( n - {n}_{0} ) = \frac{1}{A} \frac{S - {S}_{0}}{{S}_{0}} \qquad ( 1 )$$

where d, n and n₀ are the effective thickness and the effective refractive index of the forming layer, and the refractive index of the ambient medium, respectively. S₀ is the intensity ratio for a clean solid surface in ambient solution. A is the sensitivity factor, which is determined by the optical properties of the solid sensor surface as well as the experimental conditions. In the limit of low adsorbed amounts, A is independent of the amount of the adsorbent.

The adsorbed biomolecular mass, mₒ, a parameter of interest in most cases, can to a good approximation be obtained by using De Feijter's formula

$${m}_{o} = \frac{d ( n - {n}_{0} )}{d n / d c} \qquad ( 2 )$$

where dn/dc is the refractive index increment of the adsorbent. A comparison of equations 1 and 2 illustrates that reflectometry is sensitive to variations of the surface mass, rather than the density/density profile of the formed layer. Many biomaterials are anisotropic, and variations in the orientation of a biomolecule on the surface can significantly affect the measured refractive index. The refractive index in equations 1 and 2 is thus interpreted as an effective refractive index.

In some cases dn/dc can not be independently measured, and the Lorenz-Lorentz formula is an alternative in order to deduce the mass of the adsorbent

$${m}_{o} = d ( n - {n}_{0} ) \frac{3 ( n + {n}_{0} )}{( {n}^{2} + 2 ) [ r ( {n}_{0}^{2} + 2 ) - v ( {n}_{0}^{2} - 1 ) ]} \qquad ( 3 )$$

where r and v are the specific refractivity and the partial specific volume of the biomolecules, respectively. It is apparent from equation 3 that the values of d and n must be known explicitly, in order to accurately determine the adsorbed mass. Note that a measurement based solely on reflectometry is not enough to determine both parameters independently. As we will show below, a combination of reflectometry and quartz crystal microbalance can remedy this shortcoming.

Quartz crystal microbalance (QCM) is another well established technique to study (bio)molecular binding events at the solid-liquid interface. Sensing in this case is based on the detection of changes in the electromechanical characteristics of a shear-mode oscillating piezoelectric quartz crystal upon changes in the interfacial properties of one or both of its surfaces.

One successful implementation of the QCM technique is the so-called QCM-D (QCM with dissipation monitoring). By measuring both of resonance frequency, f, and the energy dissipation, D, information about the adsorbed mass and the viscoelastic properties of the interfacial layer can be obtained. In contrast to the optical techniques, the shear motion of the interface makes this technique not only sensitive to the net mass of the biomolecules, but also to the water that is associated with or hydrodynamically coupled to the interfacial film.

In QCM-D measurements, an AC electric field is applied via conductive electrodes, commonly gold evaporated on each side of a thin (˜330 μm) AT-cut quartz crystal to excite mechanical shear oscillation at the fundamental resonance and overtone frequencies, f_{z}. In addition to the measurements of f_{z}, the damping, defined by the dissipation factor, D_{z}, is simultaneously monitored (M. Rodahl, F. Hook, A. Krozer, P. Brzezinski and B. Kasemo, Rev. Sci. Instrum., 1995, 66, 3924-3930). When a layer that is rigid is deposited on one of the electrodes, ΔD_{z} is close to zero and the adsorbed mass (including coupled water) can be directly determined from the change in resonance frequency by using the Sauerbrey relation

mₐ=C/z×Δf_{z} (4)

where z is the overtone number (z=1, 3, 5 . . . ) and C=−17.7 ng/(cm²·Hz) is the mass sensitivity constant for a crystal with a fundamental frequency of 5 MHz.

If the adsorbed layer is not rigid (ΔD_{z}>0), determination of the adsorbed mass and the viscoelastic properties of the probed layer requires the use of a viscoelastic representation of the layer. At a single frequency, it is possible to model the layer by an effective thickness, d_{effec}, an effective density, ρ_{effec}, an effective shear elasticity, μ, and an effective shear viscosity, η. The mass uptake can then be determined by

mₐ=ρ_{effec}d_{effec} (5)

The density of the layer lies within a relatively narrow range that is limited by the density of the aqueous surrounding, ρₛ, and by the density of the biomolecules, ρ, respectively. In practice, ρ_{effec} is therefore used as a fixed parameter for the viscoelastic model. The effective thickness is then the output of the modeling that gives the best fit between the model and the experimental data. Previous work has shown that the uncertainty in guessing the effective density has a negligible influence on the determination of the mass. As mentioned above, and in contrast to reflectometry, the mass determined by QCM-D includes solvent that is either bound or hydrodynamically coupled to the adsorbing film. By combining the two techniques, detected masses satisfy

mₐ=mₒ+mₛ (6)

For an adsorption process that obeys equation 2, the quantification of coupled solvent according to Eq. 6 is straightforward. Under the assumption that reflectometry and QCM-D sense the same effective thickness, d_{effec}, detected masses are also governed by

$$\frac{{m}_{a}}{{ρ}_{effec}} = \frac{{m}_{o}}{ρ} + \frac{{m}_{a} - {m}_{o}}{{ρ}_{s}} . \qquad ( 7 )$$

When the Lorenz-Lorentz formula is used in order to obtain the biomolecular mass, mₒ, it can be found, by substituting equation 3 into equation 7, that the effective refractive index, n, satisfies the polynomial equation

n³+(Q−nₒ−V)n²+2n−(2n₀+2V+Qn₀²)=0 (8)

where

$$\begin{matrix}V = \frac{1}{A} \frac{S - {S}_{0}}{{S}_{0}} \frac{{ρ}_{s}}{{m}_{a}} & ( 8 a ) \\ Q = \frac{1}{{m}_{a}} \frac{{ρ}_{s} - ρ}{ρ} \times \frac{3}{r ( {n}_{0}^{2} + 2 ) - v ( {n}_{0}^{2} - 1 )} \frac{1}{A} \frac{S - {S}_{0}}{{S}_{0}} & ( 8 b )\end{matrix}$$

The biomolecular mass, mₒ, and the amount of coupled solvent, mₛ, can eventually be determined.

Note that in the previous treatment, surface roughness has been neglected and all films have been assumed to be homogeneous and flat.

Despite the success in applying optical and electromechanical techniques, each technique alone has its limitations. In particular, unambiguous interpretation of the measured response in terms of physical parameters using a single technique is often not straightforward. For example, optical techniques generally provide accurate estimations of the bound mass, while information regarding the effective film thickness and the refractive index is often not easily obtained. Except in rare cases when film thickness and refractive index can be appropriately separated, this makes it difficult to deduce any information about structural changes. On the other hand, the QCM-D technique can provide reliable information about both the bound mass and the viscoelastic properties of thin films, which is directly related to the structure of the adsorbed film. However, since coupled water is in this case sensed as a mass, the amount of bound biomolecules is not easily obtained. The growing interest in biointerface science is accompanied by an increase in the complexity of biofunctionalized surfaces. Hence, there is a need for analytical approaches that allow for a more detailed characterization of biointerfaces. One powerful and attractive approach is to apply several techniques simultaneously on the same support and to correlate the outcome. Successful examples that have already been described are QCM combined with grating assisted SPR (Surface Plasmon Resonance) or ellipsometry (W. Knoll, Annu. Rev. Phys. Chem. 1998, 49, 569-638, L. E. Bailey, D. Kambhampati, K. K. Kanazawa, W. Knoll and C. W. Frank, Langmuir, 2002, 18, 479-489, A. Domack, O. Prucker, J. Ruch and D. Johannsmann, Phys. Rev. E, 1997, 56, 680-689), where the biomolecular mass and the mass of coupled solvent can be separated. In the technique where QCM is combined with SPR, a grating is etched on one of the electrodes of QCM in order to create SPR to obtain the molecular mass of the adsorbent. The fabrication of the grating, however, is complicated. On the other hand, when QCM is combined with ellipsometry, quantification from ellipsometric measurement to the molecular mass, for many non-optical users, is not trivial.

In the present invention, we present a robust technical approach of how the use of a modified detector set-up eliminates a complication in relation to the usage of prism-based optical reflectometry in contact with liquid sample suspension. Additionally we disclose how molecular interactions at a solid-liquid interface can be investigated simultaneously by QCM-D and by optical reflectometry. We show how information about the temporal variation in molecular mass on the surface can be obtained from reflectometry, while QCM-D contributes with simultaneous information regarding coupled water and structure through changes in energy dissipation. We also show how the time-resolved variations in effective refractive index and the effective thickness of the adsorbent on the surface can be derived with the combination setup, which can not be obtained by each technique alone. In one embodiment of the invention we demonstrate how the formation of a supported lipid bilayer on a silica surface can be measured simultaneously with a 4-detector reflectometry setup where adsorption on the prism can be compensated for. In the same embodiment we have shown an example of how a simultaneous QCM-D measurement can be accomplished.

### SUMMARY OF THE INVENTION

The present invention relates to a reflectometry setup which may be combined with other techniques that do not have technical interference with reflectometry when sharing the same solid sensing surface, for instance with a quartz crystal microbalance of some suitable type.

In particular the invention relates to a reflectometric setup comprising a light source that provides monochromatic polarized beam of light (1 and 2), a sensing surface of interest (3′″), a prism (4) which guides the beam of light onto the sensing surface of interest and receives light reflected from the sensing surface of interest, a polarizing component, located downstream of the sensing surface of interest in the light beam path, which separates the incident beam into two beams with orthogonal polarizations (5); and photo sensitive detectors (6, 7) arranged to detect light reflected from the sensing surface, and additionally the setup comprises two or more additional photo sensitive detectors (6′ and 7′), wherein the additional detectors are arranged to detect a light beam not reflected from the sensing surface.

In one embodiment of the invention the light source (1) providing the monochromatic polarized beam is a laser diode.

In one embodiment of the invention the light beam is polarized by a linear polarizer.

In one embodiment of the invention the incident beam is split into two beams with a cubic polarizing beamsplitter.

In one embodiment of the invention the prism (4) is a coating-free BK 7 right angle prism.

In one embodiment of the invention the prism is arranged to reflect part of the incident light beam directly to the polarizing component for detection by the additional detectors (6′ and 7′).

In one embodiment of the invention the sensing surface (3′″) is used as a combined sensing surface for reflectometry and some other technique, that does not have technical interference with reflectometry on said sensing surface (3′″).

In one embodiment of the invention the sensing surface (3′″) is a piezoelectric substrate.

In one embodiment of the invention the sensing surface (3′″) is a Quartz Crystal Microbalance.

In one embodiment of the invention the Quartz Crystal Microbalance is coated with silica.

Furthermore the invention relates to a method for measuring the mass of adsorbed molecules on a sensing surface using the reflectometry set-up as described above, said method comprising the following steps:
emitting a beam of monochromatic light from a light source (1); and
polarizing the beam with a linear polarizer (2); and
coupling the polarized beam onto a sensing surface (3′″) coated by the adsorbed molecule, via a prism (4); and
separating the outgoing beam (I₁) reflected from the sensing surface (3′″) into p- and s-polarized light having the intensities I₁ₚ and I1ₛ, using orthogonal polarizations (5); and
monitoring the intensities, I₁ₚ and I₁ₛ by two photo sensitive detectors (6 and 7); and
separating the outgoing beam (I₂) reflected from the bottom of the prism (4), into p- and s-polarized light having the intensities I₂ₚ and I₂ₛ, with the same cubic polarizing beamsplitter (5); and
monitoring the intensities, I₂ₚ and I₂ₛ by two photo sensitive detectors (6′ and 7′).

In another embodiment of the invention the contribution from the reaction at the surface of the prism is used to correct the optical output from the sensing surface (3′″).

In another embodiment of the invention characteristics of the adsorbed molecules on the sensing surface (3′″) are measured simultaneously with other techniques that do not have technical interference with reflectometry when sharing the same sensing surface (3′″).

In another embodiment of the invention the adsorbed mass and the viscoelastic properties of the adsorbed molecules as well as the water that is associated with, or hydrodynamically coupled to said molecules on the sensing surface (3′″) are measured simultaneously on the same sensing surface (3′″) using QCM-D technique.

In another embodiment of the invention time-resolved variations in effective refractive index and the effective thickness of the adsorbed molecules on the sensing surface (3″) are determined.

In another embodiment of the invention the adsorbed molecules are biomolecules.

In another embodiment of the invention the adsorbed biomolecules are from the group comprising antibodies, synthetic antibodies, antibody fragment, antigens, synthetic antigens, haptens, nucleic acids, synthetic nucleic acids, cells, receptors, hormones, proteins, prions, lipids, polymers, drugs, enzymes, carbohydrates, biotins, lectins, bacteria, virus and/or saccharides.

Furthermore the invention also relates to a system for measuring the mass of adsorbed molecules on a sensing surface, comprising: a reflectometry setup as described above and a measurement control and analysis device.

### BRIEF DESCRIPTION OF THE DRAWINGS

FIG. 1. A schematic representation of a conventional two-detector reflectometry setup according to known technology.

FIG. 2. A schematic representation of the combined two-detector reflectometry and QCM-D setup according to one embodiment of the present invention.

FIG. 3. Responses obtained with the combined reflectometry/QCM-D setup for POPC bilayer formation on a silica surface via vesicle fusion.

FIG. 4. Reflectometry responses obtained upon exposing POPC vesicles to a bare and a PLL-g-PEG coated silica surface.

FIG. 5. A schematic representation of the combined four-detector reflectometry and QCM-D setup according to one embodiment of the present invention.

FIG. 6. An optical model representing the four detector reflectometry system according to the present invention.

FIG. 7. Time-resolved variation of the total mass, the biomolecular mass and the solvent mass, as determined with the combined setup.

FIG. 8. Time-resolved variations of the effective refractive index and the effective thickness of lipid on the silica surface during a bilayer formation, as determined with the combined setup.

FIG. 9. A schematic representation of the modified four-detector reflectometry set-up according to the present invention.

FIG. 10. A schematic representation of the modified four-detector reflectometry set-up combined with other techniques that do not have technical interference with reflectometry when sharing the same solid sensing surface, according to the present invention.

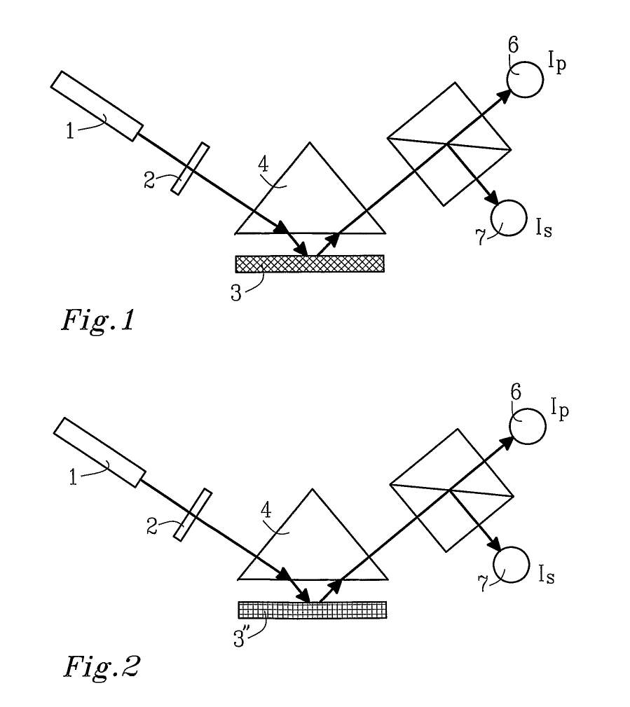

### DETAILED DESCRIPTION OF THE INVENTION

A sever complication in relation to the usage of prism-based optical reflectometry setups in contact with a fluid sample is that the optical properties of the prism surface in contact with the sample might change during the cause of the measurement. Consequently, a reaction taking place at the bottom of the prism will likely result in a non-negligible distortion of the optical output. It will in this case not be possible to extract how much of the measured optical signal is due to reactions at the prism surface or the surface under study. The present invention eliminates this shortcoming by means of a modification of the setup to simultaneously monitor the beam reflected from the bottom of the prism, which can be accomplished by using four detectors instead of two when monitoring the reaction taking place at the sensor surface.

This four detector system can be used on its own or in combination with other techniques. As an example, we have developed and validated an experimental setup, with which QCM-D data and reflectometric data can be acquired simultaneously on the same surface. The temporal resolution and the mass resolution obtained with the combined setup are similar to what can commonly be obtained with each method individually. With the combined setup, structural transformations, mechanical properties, biomolecular masses and the hydration of thin biomolecular films on solid surfaces can be monitored at the same time on the same substrate. The combined setup thus provides a powerful method to characterize e.g. complex biomolecular interactions or the behavior of polymeric layers on surfaces.

In the following section the invention will be described in more detail. However, the described embodiments mentioned below are only given as an illustration of the present invention and should not be limiting to the scope of protection. Other solutions, uses, objectives, and functions within the scope of the invention as claimed in the below described patent claims should be apparent for the person skilled in the art.

In one embodiment of the present invention, the two techniques reflectometry and QCM-D are combined in the same setup, which is illustrated by the schematic drawing in FIG. 2. A reflectometry experimental setup, comprising a laser diode, a linear polarizer, a coating-free prism, a cubic polarizing beamsplitter and two photo diodes, is mounted in a modified Q-Sense E4 system provided by Q-Sense (Q-Sense AB, Gothenburg, Sweden) which handles the QCM-D data acquisition and the temperature control. An additional, computer-controlled electronic unit is used to control the laser diode and to collect the optical signals. A custom-designed flow chamber, made of titanium, is used to accommodate the sensor crystal and to provide laminar flow of the sample to be deposited onto the silica coated QCM-D quartz crystal surface. The volume between the bottom of the prism and the surface of the sensor crystal to hold liquid samples is about 120 μL.

However, any setup comprising a light source that provides a monochromatic polarized beam (1 and 2), a thin layer of interest deposited directly or indirectly via other layers on top of a piezoelectric substrate that is simultaneously used as the sensing element of reflectometry (3″), a prism which guides the beam of light onto the sensing surface and then receives light reflected from the same sensing surface, (4), a polarizing component which can separate the incident beam into two beams with orthogonal polarizations (5) and photo detectors (6, 7), can be used to carry out this embodiment of the present invention. Thus in this combined set up the coated surface of a quartz crystal (3″) also serves as the sensing surface of reflectometry.

The quartz crystal surface used in the above combination set-up, is obtained from Q-Sense (Q-Sense AB, Gothenburg, Sweden), and is silica-coated. However, crystal surfaces coated with thin layers of other materials (i.e. gold) can also be used. As the QCM-D surface also serves as the sensing surface for the reflectometry measurements, it is important that the optical property of the facial thin layer and the substrate as a whole follows the requirements of Eq. 1. Prior to the measurements, the surfaces were immersed in a 2% sodium dodecyl sulfate (SDS) solution for 20 minutes, rinsed with water, blow-dried with nitrogen, and exposed to UV/ozone by using a home made UVO cleaner for 20 minutes.

The prism used in this set up is a coating-free BK 7 right angle prism. Other prisms which guide the incident light onto the sensing surface may also be used.

Other optical components, in addition to the polarizing beamsplitter, which are capable of separating one incident beam into two beams having orthogonal polarizations, may also be used.

The photo detectors (6, 7) may be any photo sensitive detectors, e.g. photo diodes or photo multipliers.

The liquid lipid vesicle suspension (the POPC vesicles) which was used to evaluate the combined experimental setup disclosed in the present invention has been described in detail previously and therefore provides a well-defined reference system (E. Reimhult, C. Larsson, B. Kasemo and F. Hook, Anal. Chem., 2004, 76, 7211-7220). This suspension was prepared as follows: 1-Palmitoyl-2-Oleoyl-sn-Glycero-3-Phosphocholine (POPC) was purchased from Avanti Polar Lipids (Alabaster, Ala., USA) and all other chemicals were from Sigma-Aldrich. Water was ultrapure water from a MilliQ unit (MilliPore, France) (resistivity >18 MΩ/cm). Buffer was Tris buffer (10 mM Tris, 100 mM NaCl, pH 8). POPC vesicles were prepared by extrusion of a lipid suspension (buffer was added to a vial in which a lipid film had been formed on the walls through evaporation of chloroform) through polycarbonate membranes having a pore diameter of 0.1 μm 25 times followed by additionally 15 times through membranes of pore diameter 0.03 μm. Vesicle solutions were stored at 4° C. under nitrogen atmosphere until use.

The person skilled in the art of reflectometry, other optical techniques and/or QCM-D realize that the present invention is not limited to the above described lipid vesicles, but any kinds of molecules that can be studied with these techniques can also be examined using the set-up of the present invention. Molecules of interest may comprise molecules of the following group: antibodies, synthetic antibodies, antibody fragment, antigens, synthetic antigens, haptens, nucleic acids, synthetic nucleic acids, cells, receptors, hormones, proteins, prions, lipids, polymers, drugs, enzymes, carbohydrates, biotins, lectins, bacteria, virus and/or saccharides, but are not in any way limited to this group.

In the combination detector setup (FIG. 2) used in the above described embodiment of the present invention, the lipid bilayer formation was measured as followed: All measurements are performed at a temperature of 22° C. Liquid solutions are delivered to the chamber by a peristaltic pump. Prior to each measurement, the mounted crystal is cleaned in situ by subsequent additions of SDS (10 mM), water and buffer for 1 minute each at speed flow (i.e. the maximum flow of the pump), and stable baselines both in QCM-D and reflectometric response must be obtained. Thereafter, a flow rate of 175 μl/min for the sample is used unless otherwise stated. In the lipid bilayer experiment, a lipid vesicle concentration of 0.2 mg/ml is used, followed by rinsing with buffer. A beam of monochromatic light, emitted by a laser diode (1) is polarized by a linear polarizer (2) and subsequently coupled onto a solid surface, i.e. the silica coated QCM-D quartz crystal surface (3″), via a coating-free BK 7 right angle prism (4). The outgoing beam is separated into p- and s-polarized light with a cubic polarizing beamsplitter (5) and the intensities, Iₚ and Iₛ of the reflected beam are monitored by two photo diodes (6 and 7). The angle of incidence of the probing beam inside the prism is fixed at about 56.1°.

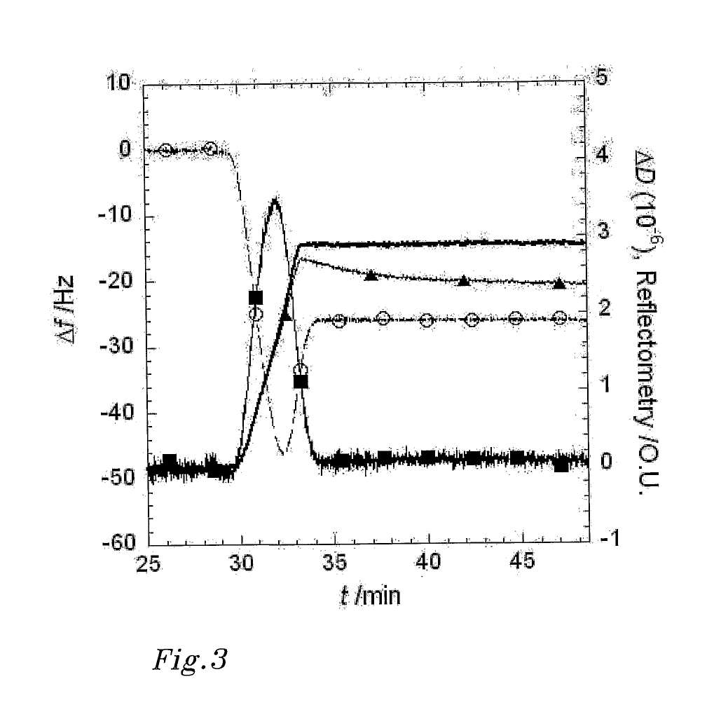

The example used in this work was based on the process of formation of a supported lipid bilayer on silica. However, the choice of system, i.e. the POPC vesicle suspension, in combination with a prism-based reflectometry setup, proved to result in complications due to the fact that the prism material was not inert to the lipid molecule. The impediment was manifested as an obstruction of the optical output via the appearance of a negative slope during bilayer formation. In FIG. 3, the QCM-D signals (-∘- and -▪-) clearly show that a high quality bilayer is formed and the mass uptake is ended at t=˜34 min. The optical signal obtained with reflectometry using the two-detector setup (-▴-), however, indicates that the process still continues and ends at t=˜40 min. The optical signal in this time interval can not be explained by the conventional understanding of the mechanism of bilayer formation on a silica surface.

In order to further investigate the observed drift, the sensor surface was made passive such that the interaction with vesicles was suppressed. The silica-coated QCM-D quartz crystal surface was deposited by poly(L-lysine) and poly (ethylene glycol) (PLL-g-PEG, generously provided by the Laboratory for Surface Science and Technology, ETH-Zürich). PLL-g-PEG is a molecule which is resistant to protein and lipid adsorption. The silica-coated QCM-D quartz crystal was immersed in SDS (Sodium dodecyl Sulphate) solution (10 mM) over night, rinsed with water and treated with UV/ozone 2×1h. The crystal was thereafter soaked in a PLL-g-PEG bath for 3 h (0.1 mg biotin-PLL-g-PEG per ml Buffer (10 mM HEPES, 150 mM NaCl, pH7.4) after which it was rinsed with water, dried with N₂ and mounted in the measurement cell.

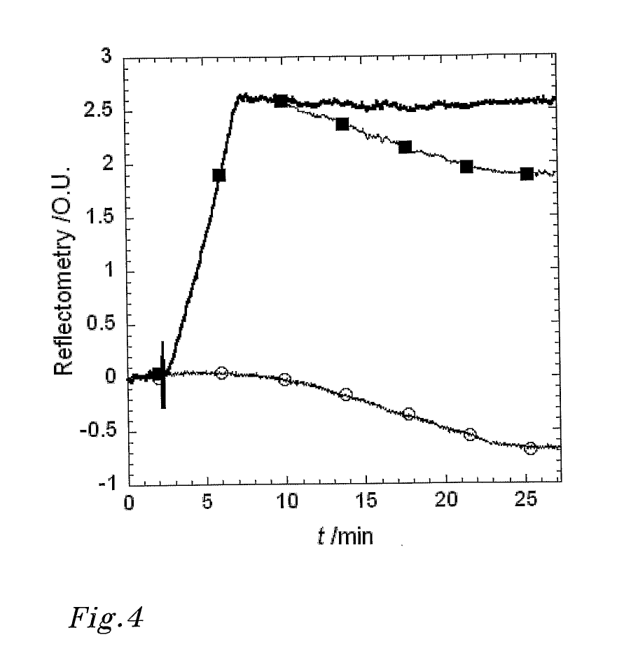

This passivation of the sensor surface revealed that the surface of the prism was not inert to lipids; when the sensor surface was coated with lipid inert PLL-g-PEG, a “drift” similar to that previously observed still appeared. This can be seen in FIG. 4, where the reflectometric responses obtained upon exposure of a bare (-▪-) and a PLL-g-PEG coated silica surface (-∘-), to POPC vesicles. Also shown is the net response (−), i.e. the difference between the two contributions.

It was concluded that the lipid adsorption at the bottom of the prism alters the transmittance of the probe beam into/off the prism bottom/bulk interface, and thereby distorts the signal significantly resulting in the observed ‘drift’.

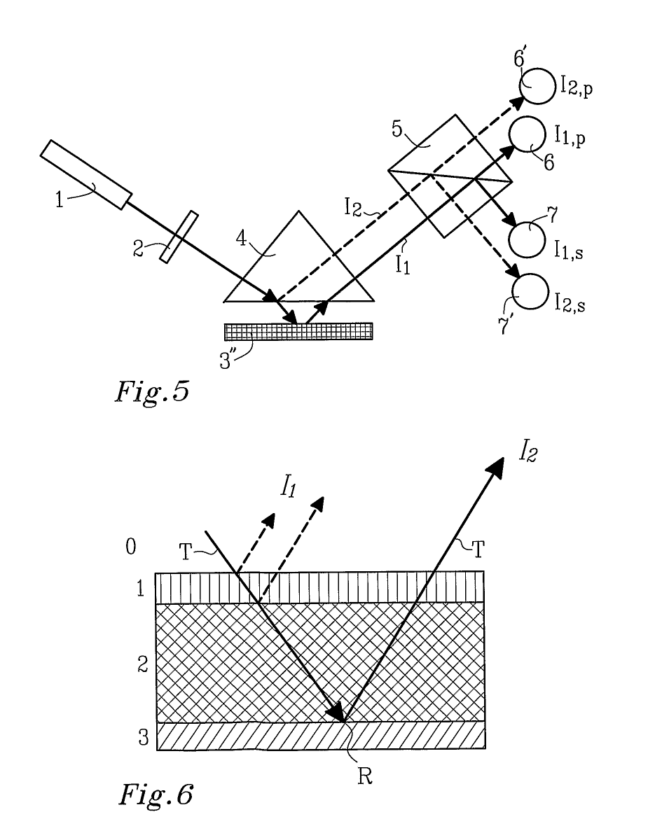

Thus, in another embodiment of the present invention the combined set-up has been modified by the addition of two detectors (6′ and 7′) in order to correct for the resulting transmittance change. This modified set-up is illustrated in FIG. 5. Via these detectors, (6′ and 7′), the light reflected from the bottom of the prism may be monitored, and the contribution from the reaction at the surface of the prism may accordingly be compensated for in the optical output. In FIG. 3, the bilayer formation via vesicle fusion on SiO₂, recorded by QCM-D (Δf=-∘- and ΔD=-▪-) and reflectometry can be seen. The reflectometry data recorded using a conventional set-up are shown with -▴- (2 detector set-up), whereas data corrected for binding of material to the surface of the prism are shown with the line having no mark (4 detector set-up). When monitoring the formation of a supported lipid bilayer with the 4-detector setup, the previously observed negative slope does not appear.

Thus, the solution to the problem with the adsorbed lipid bilayer at the surface of the prism giving rise to the “drift” in the signal from the sensor surface, is to use an additional beam (dashed lines in FIG. 5) to determine changes in the total transmission (forth and back from the prism to the bulk solution) caused by adsorption to the bottom of the prism and to correct the intensities of the beam reflected from the sensor surface.

The four detector system may be represented by a model as shown in FIG. 6. The prism, adhering layer, bulk solution media and the sensor surface are indexed 0, 1, 2 and 3, respectively. The reflectance and the transmittance are denoted by T and R, and the intensities of the first and second beam are denoted by I¹ and I². If there is no adhering layer, the transmittance, T, and the reflectance, R, are described by the following equations,

t₀₂ₚt₂₀ₚ=1−r₀₂ₚ²=1−R₀₂ₚ (9a)

t₀₂ₛt₂₀ₛ=1−r₀₂ₛ²=1−R₀₂ₛ (9b)

i.e.

T₀₂ₚT₂₀ₚ=(1−R₀₂ₚ)² (10a)

T₀₂ₛT₂₀ₛ=(1−R₀₂ₛ)² (10b)

where tᵢⱼ and rᵢⱼ are the transmission- and the reflection coefficients for p- and s-polarized light respectively, which then are transmitted through the interface i-j and reflected at the interface i-j. Tᵢⱼ and Rᵢⱼ denote the corresponding transmittance and reflectance, respectively. Simulation shows that the Eqs 9-10 are also valid in the presence of an optically transparent adhering layer or layers, i.e.

T₀₁₂ₚT₂₁₀ₚ=(1−R₀₁₂ₚ)² (11a)

T₀₁₂ₛT₂₁₀ₛ=(1−R₀₁₂ₛ)² (11b)

The reflected intensities of the two beams are related by

I₂ₚ=K₂ₚT₀₁₂ₚRₚT₂₁₀ₚ=RₚK₂ₚ(1−I₁ₚ/K₁ₚ)² (12a)

I₂ₛ=K₂ₛT₀₁₂ₛRₛT₂₁₀ₛ=RₛK₂ₛ(1−I₁ₛ/K₁ₛ)² (12b)

where, I₁ and I₂ are the measured intensities of the two beams. K₁ and K₂ are system constants that depend on optical losses at the prism surface and the sensitivity of the photo detectors. R is the reflectance at the sensor surface. Eq. 12 gives

$$\begin{matrix}{R}_{p} = \frac{{I}_{2 p}}{{{K}_{2 p} ( 1 - {I}_{1 p} / {K}_{1 p} )}^{2}} & ( 13 a ) \\ {R}_{s} = \frac{{I}_{2 s}}{{{K}_{2 s} ( 1 - {I}_{1 s} / {K}_{1 s} )}^{2}} & ( 13 b )\end{matrix}$$

The information at the sensor surface can thereafter be obtained by substituting Rₚ and Rₛ into Eq. 1 with the redefined S=Rₚ/Rₛ, while K₂ vanishes in doing so. A calibration is essential to obtain K₁. It can be easily done by using a solution with known refractive index as follows.

I₁ₚ=K₁ₚ|r₀₂ₚ|² (14a)

I₁ₛ=K₁ₛ|r₀₂ₛ|² (14b)

where r₀₂ₚ and r₀₂ₛ are the reflection coefficients for p- and s-polarized light at the prism/bulk solution interface. These can be obtained by using Fresnel's equation with known parameters, i.e. the refractive index of the prism, the refractive index of the bulk solution and the angle of incidence of the probe beam. It is essential that the bottom surface of the prism is bare during the calibration. When using reflectometry in biomaterial studies, almost all measurements are initialized with pure solution, e.g. buffer solution, until a stable baseline is obtained. This can be used as calibration if the refractive index of the solution is known.

Example: Quantification of adsorbed masses using the combined reflectometry and QCM-D set-up.

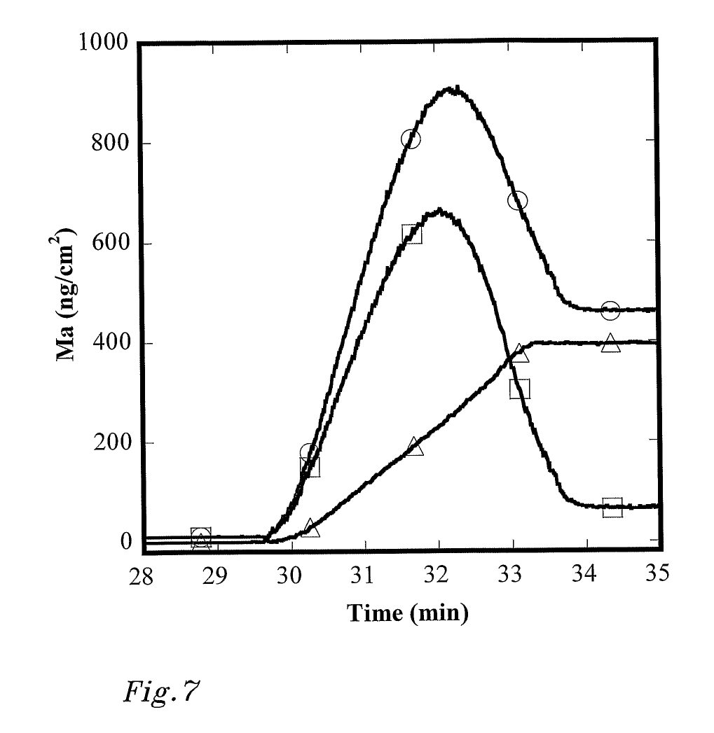

The adsorbed masses, i.e. the total mass obtained by QCM-D (-∘-), the biomolecular mass (-Δ-) as determined by reflectometry and the contribution of the hydrodynamically coupled solvent to the QCM-D response (-□-) are shown in FIG. 7. The QCM-D mass was calculated with the viscoelastic model as implemented in the software QTools (Q-Sense, Gothenburg, Sweden). The biomolecular mass and the coupled solvent were obtained by using Eqs. 7 and 8. Parameters used for the calculation were: ρₛₒₗᵥₑₙₜ=1.0 g/cm³, r=0.286 cm³/g, ρ_{bio}=1.02 g/cm³, v=1/ρ_{bio}=0.98 cm³/g and n₀=1.334. The monotonous increase in lipid molecular mass and the bending behavior of water content in FIG. 5, strongly support the proposed scenario that the lipid vesicles are initially adsorbed on silica surface and then start to rupture into bilayer patches with water release after a critical coverage is reached. The lipid masses adsorbed at equilibrium, i.e. the molecular mass of the formed lipid bilayer, measured with our combined setup, as can be seen in FIG. 7, is ˜400 ng/cm². This value is in good agreement with the mass reported in literature (E. Reimhult, C. Larsson, B. Kasemo and F. Hook, Anal. Chem., 2004, 76, 7211-7220) and provides evidence that our setup is well calibrated and that adsorbed amounts can be determined quantitatively.

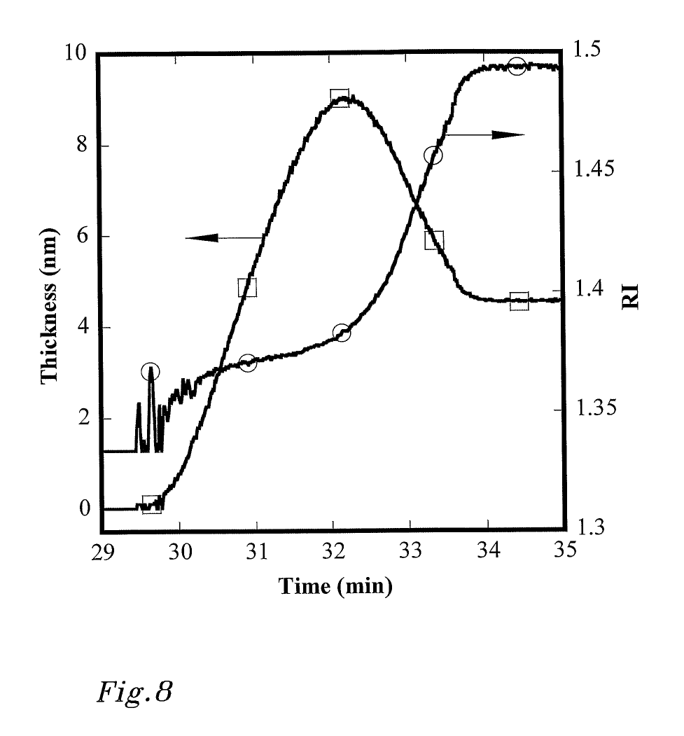

With the combined setup, the effective refractive index and the thickness of lipid on the silica surface during the bilayer formation can also be obtained (shown in FIG. 8), which can not be determined by each technique alone. From FIG. 8 it can be seen that the refractive index and the thickness of the formed bilayer is about 1.49 and 4.5 nm respectively.

The short-term peak to peak noise in the setup used in the present invention was found to be 0.015% and 0.1 Hz for reflectometry and QCM-D, respectively (not shown). This corresponds to a mass resolution of 1.8 ng/cm² for QCM-D, if the Sauerbrey equation is used for reference, and 1.7 ng/cm² for reflectometry, given a refractive index increment that is representative for proteins (dn/dc=0.186 cm³/g). These values are in the range of what is commonly obtained for individual setups of high quality. Note that the mass resolution of a reflectometric system strongly depends on the sensitivity factor of the solid surface employed. Similarly, the adsorbed mass measured with QCM-D depends on the hydration, which means that the sensitivity in terms of signal per biomolecular mass differs for different systems.

In the disclosure above it is illustrated how the problem of prism-related adsorption during reflectometric measurements can be solved with the addition of two extra detectors (FIG. 5). The QCM-D technique as used in combination with reflectometry proved to be an excellent method for evaluating and exploring the observed “drift” phenomena. As mentioned above, under certain circumstances this prism-related artefact must be taken into account and corrected for during measurement. However, this situation does not necessarily occur only in the combination setup described above, but appears whenever the prism characteristics are such that the sample can adsorb on its surface. Thus, in one further embodiment of the present invention the four detector reflectometry setup may be used by itself (i.e. without using its sensing surface as the surface of a QCM-D sensor).

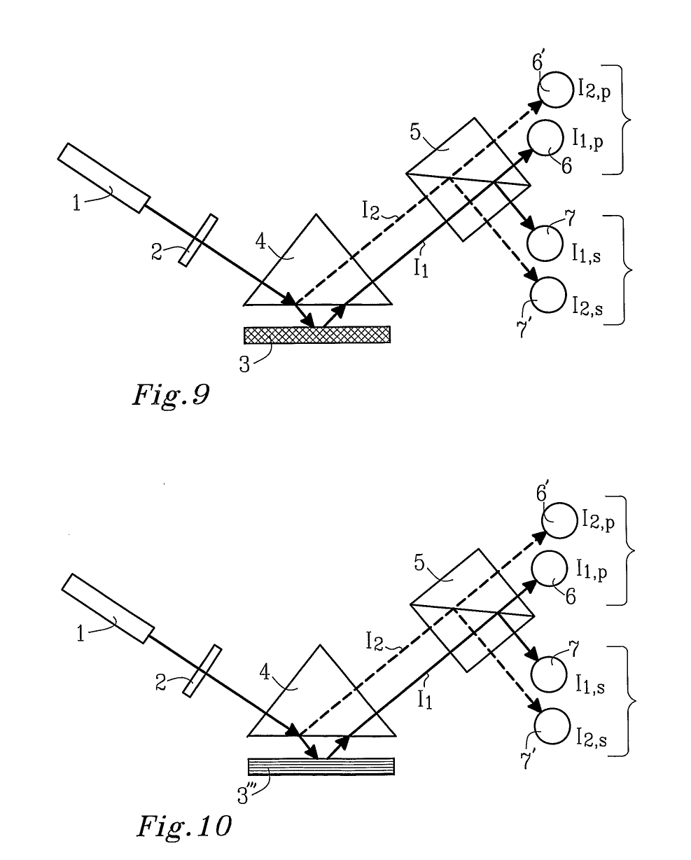

A schematic view of the four detector set-up of the present invention when used alone can be seen in FIG. 9. This reflectometric set-up comprises a light source that provides a monochromatic polarized beam of light (1 and 2), a reflectometry sensing surface of interest (3). The set-up further comprises a prism (4) which guides the beam of light onto the sensing surface of interest and then receives light reflected from the same sensing surface, a polarizing component which can separate the incident beam from the prism into two beams with orthogonal polarizations (5) and four or more photo sensitive detectors (6, 7 and 6′, 7′), wherein two or more detectors (6, 7) are arranged to detect light reflected from the sensing surface, and two or more detectors (6′, 7′) are arranged to detect the light reflected from the bottom of the prism.

In such a set up the adsorption of molecules of interest is measured as follows: A beam of monochromatic light, emitted by a laser diode (1) is polarized by a linear polarizer (2) and subsequently coupled onto a sensing surface (3), which is being coated by the molecules of interest, via a prism (4). The outgoing beam (I₁) reflected from the sensing surface (3) is separated into p- and s-polarized light, using orthogonal polarizations (5) and the intensities, I₁ₚ and I₁ₛ of the reflected beam are monitored by two photo detectors (6 and 7). In order to determine the changes in the total transmission (forth and back from the prism to the bulk solution) caused by adsorption of the molecules to the bottom of the prism, the outgoing beam (I₂) which is reflected from the bottom of the prism (4), is separated into p- and s-polarized light with the same cubic polarizing beamsplitter (5), and the intensities, I₂ₚ and I₂ₛ of the reflected beam are monitored by two photo detectors (6′ and 7′). Thus, the intensities of the beam reflected from the sensor surface (3) can be corrected by using the relationship described by Eq. 13. The response obtained with the four detector reflectometry set-up for POPC bilayer formation on a silica surface via vesicle fusion can be seen in FIG. 3 in the trace having no mark.

Furthermore, in yet another embodiment of the present invention, the four detector reflectometry setup may also be combined with other techniques that do not have technical interference with reflectometry when sharing the same solid sensing surface. An illustration of such a set-up is seen in FIG. 10. In this embodiment the set-up comprises the essential elements of the four detector reflectometry device as described for FIG. 9, i.e. a light source that provides a monochromatic polarized beam of light (1 and 2), a reflectometry sensing surface of interest (3′″), a prism (4) which guides the beam of light onto the sensing surface of interest (3′″) and then receives light reflected from the same sensing surface, a polarizing component which can separate the incident beam from the prism into two beams with orthogonal polarizations (5) and four or more photo sensitive detectors (6, 7 and 6′, 7′), wherein two or more detectors (6, 7) are arranged to detect light reflected from the sensing surface (3″), and two or more detectors (6′, 7′) are arranged to detect the light reflected from the bottom of the prism (4). In this combined set-up the properties of the sensing surface (3′″) which is used as a combined sensing surface for reflectometry and some other technique, must be such that they that do not have technical interference with reflectometry on this surface. Most importantly is that the optical properties of the sensing surface of interest (3′″), have to as a whole follow the requirements of Eq. 1.

In addition to the embodiment described above, i.e. the combined set-up with 4-detector reflectometry and QCM-D, the Surface Acoustic Wave (SAW) technique is another example of a technique which successfully may be combined with the 4-detector reflectometry set-up according to the present invention.

The present invention may be implemented as a system together with a control and analysis device, comprising at least one processing unit, at least one memory unit, and at least one communication interface for communicating with the measurement setup according to the present invention and/or with an external network for distributing data. Analysis of measurement signals from the measurement setup may advantageously be done using analysis algorithms and signal conditioning methods implemented as software in the processing unit. Data (raw and/or analyzed) may be presented on a display device (for instance computer screen). It should be appreciated that the control and analysis device may be incorporated together with suitable control electronics arranged to control the measurement setup and that conditioning of measurement signals may be provided also at least in part as hardware (e.g. filtering and averaging functions may be performed in electronics circuitry). Furthermore, AD/DA circuitry may be provided for digitizing signal to the processing unit and for converting digital signals to analog signals for controlling the measurement setup.

The above mentioned and described embodiments are only given as examples and should not be limiting to the present invention. Other solutions, uses, objectives, and functions within the scope of the invention as claimed in the below described patent claims should be apparent for the person skilled in the art.

1. A reflectometric arrangement comprising:
a light source that provides monochromatic polarized beam of light,
a sensing surface of interest,
a prism which guides the beam of light onto the sensing surface of interest and receives light reflected from the sensing surface of interest,
a polarizing component, located downstream of the sensing surface of interest in the light beam path, which separates the incident beam into two beams with orthogonal polarizations;
photo sensitive detectors arranged to detect light reflected from the sensing surface, and
two or more additional photo sensitive detectors, arranged to detect a light beam not reflected from the sensing surface.

2. A reflectometric arrangement according to claim 1, wherein the light source providing the monochromatic polarized beam is a laser diode.

3. A reflectometric arrangement according to claim 1, wherein the light beam is polarized by a linear polarizer.

4. A reflectometric setup according to claim 1, wherein the incident beam is split into two beams with a cubic polarizing beamsplitter.

5. A reflectometric arrangement according to claim 1, wherein the prism is a coating-free BK 7 right angle prism.

6. A reflectometric arrangement according to claim 1, wherein the prism is arranged to reflect part of the incident light beam directly to the polarizing component for detection by the additional detectors.

7. A reflectometric arrangement according to claim 1, wherein the sensing surface is used as a combined sensing surface for reflectometry and some other technique, that does not have technical interference with reflectometry on said sensing surface.

8. A reflectometric arrangement according to claim 1, wherein the sensing surface is a piezoelectric substrate.

9. A reflectometric arrangement according to claim 1, wherein the sensing surface is a Quartz Crystal Microbalance.

10. A reflectometric arrangement according to claim 9, wherein the Quartz Crystal Microbalance is coated with silica.

11. A method for measuring the mass of adsorbed molecules on a sensing surface using the reflectometry arrangement according to claim 1, comprising the following steps:
emitting a beam of monochromatic light from a light source; and
polarizing the beam with a linear polarizer; and
coupling the polarized beam onto a sensing surface coated by the adsorbed molecule, via a prism; and
separating the outgoing beam reflected from the sensing surface into p and s-polarized light having the intensities I₁ₚ and I₁ₛ, using orthogonal polarizations; and
monitoring the intensities, I₁ₚ and I₁ₛ by two photo sensitive detectors; and
separating the outgoing beam reflected from the bottom of the prism, into p- and s-polarized light having the intensities I₂ₚ and I₂ₛ, with the same cubic
polarizing beamsplitter; and
monitoring the intensities, I₂ₚ and I₂ₛ by two photo sensitive detectors.

12. A method according to claim 11, wherein the contribution from the reflection at the bottom surface of the prism is used to correct optical output from the sensing surface, comprising monitored intensities I₁ₚ and I₁ₛ.

13. A method according to claim 11, wherein characteristics of the adsorbed molecules on the sensing surface are measured simultaneously with other techniques that do not have technical interference with reflectometry when sharing the same sensing surface.

14. A method according to claim 13, wherein the adsorbed mass and the viscoelastic properties of the adsorbed molecules as well as the water that is associated with, or hydrodynamically coupled to said molecules on the sensing surface are measured simultaneously on the same sensing surface using QCM-D technique.

15. A method according to claim 14, wherein time-resolved variations in effective refractive index and the effective thickness of the adsorbed molecules on the sensing surface are determined.

16. A method according to claim 13, wherein the adsorbed molecules are biomolecules.

17. A method according to claim 16, wherein the adsorbed biomolecules are from the group comprising antibodies, synthetic antibodies, antibody fragment, antigens, synthetic antigens, haptens, nucleic acids, synthetic nucleic acids, cells, receptors, hormones, proteins, prions, lipids, polymers, drugs, enzymes, carbohydrates, biotins, lectins, bacteria, virus and/or saccharides.

18. A system for measuring the mass of adsorbed molecules on
a sensing surface, comprising:
a reflectometry setup according to claim 1;
a measurement control and analysis device.
